(19) United States
(12) Patent Application Publication
(10) Pub. No.: US 2007/0144685 A1
(43) Pub. Date: Jun. 28, 2007

(54) Obstacle detection stopping device of solar radiation shielding

(75) Inventor: Tomomichi Chigusa, Tochigi (JP)

Correspondence Address: HARNESS, DICKEY & PIERCE, P.L.C., P.O. BOX 828, BLOOMFIELD HILLS, MI, 48303, US

(73) Assignee: TACHIKAWA CORPORATION, TOKYO (JP)

(21) Appl. No.: 10/583,174

(22) PCT Filed: Dec. 17, 2004
(86) PCT No.: PCT/JP04/18884

§ 371 Date: Sep. 14, 2006

(30) Foreign Application Priority Data
Dec. 18, 2003 (JP) 2003-421401

(51) Int. Cl. E06B 9/30

(52) U.S. Cl. 160/170

(57) ABSTRACT

An obstacle detection stopping device of a solar radiation shielding apparatus capable of suppressing the wear of a lifting cord due to the contact of a slat with the lifting cord. The obstacle detection stopping device (10) comprises a support member (11), a rotary drum (13), a cam clutch (12), and a winding pulley (9). A drive shaft (8) is passed through the inside of the device. A rotating force in the unwinding direction is transmitted to the drive shaft (8) by a tension applied to the winding pulley (9). The rotary drum (13) is integrally fitted to the drive shaft (8), and the cam clutch (12) is fitted to the outer edge thereof so as to be rotated relative to each other. Based on the relative rotation of the cam clutch (12) to the rotary drum (13), the cam clutch (12) is moved along its axial direction to change the state of its engagement with a braking projected part (11g). The cam clutch (12) is installed so as to be non-rotated relative to the winding pulley (9). When the tension applied to the winding pulley (9) is eliminated, the cam clutch stops its rotating motion together with the winding pulley (9), and based on the relative rotation thereof to the rotary drum (13), the cam clutch is engaged with the braking projected part (11g).

### TECHNICAL FIELD

The present invention relates to an obstacle detection stopping device of a solar radiation shielding apparatus.

### BACKGROUND ART

In a conventional technique, a horizontal type blind is provided with an obstacle detection stopping device which stops unwinding of a lifting cord to stop lowering of slats and a bottom rail when the bottom rail collides with an obstacle during lowering of the slats; and such an obstacle detection stopping device of a solar radiation shielding apparatus has been disclosed many times. Such obstacle detection stopping device includes a collision detection means which detects that a bottom rail collides with an obstacle and a lowering stopping means which stops unwinding of a lifting cord on the basis of collision of the obstacle with a bottom rail.

An obstacle detection stopping device of a solar radiation shielding apparatus disclosed in a patent document 1 includes springs and a stop ring as a collision detection means; and gears as a lowering stopping means. The collision detection means detects collision with a bottom rail and an obstacle on the basis of slack of a lifting cord; and the lowering stopping means stops lowering of slats and the bottom rail on the basis of the slack of the lifting cord. More specifically, the stop ring is penetrated by the lifting cord and biased by the springs toward the gear direction; and the stop ring moves toward the gear direction by biasing force of the springs so as to be engaged with the gears when the slack is generated in the lifting cord. Then, it is configured that the stop ring is engaged with the gears, whereby unwinding of the lifting cord can be stopped; and the stop ring is engaged with the gears, whereby the lowering of the bottom rail is stopped.
Patent document 1: Japanese Registered Utility Model No. 2546419

### DISCLOSURE OF THE INVENTION

### Problems to be Solved by the Invention

However, in the obstacle detection stopping device of the solar radiation shielding apparatus described in the patent document 1, when the slack of the lifting cord is detected, the lifting cord is led in the horizontal direction; and therefore, there is a case that the lifting cord sways in that direction. In such a case, the lifting cord comes in contact with the slats and therefore wear of the lifting cord is likely to be speeded up.

Furthermore, in the obstacle detection stopping device of the solar radiation shielding apparatus described in the patent document 1, the stop ring needs to be arranged radially outside a roll-up drum in order to detect the slack of the lifting cord. Therefore, there is a problem in that the stop ring protrudes radially outside the roll-up drum and a head box for accommodating the roll-up drum and the stop ring becomes larger.

The present invention is implemented to solve the foregoing problem, and a first object of the present invention is to provide an obstacle detection stopping device of a solar radiation shielding apparatus capable of suppressing wear of a lifting cord due to contact of slats with the lifting cord. Furthermore, a second object of the present invention is to provide an obstacle detection stopping device of a solar radiation shielding apparatus capable of reducing in size of a head box.

### Means for Solving Problem

To attain the aforementioned object, according to first aspect of the present invention, there is provided an obstacle detection stopping device of a solar radiation shielding apparatus, which rotatably supports a winding pulley; supports a solar radiation shielding member by a lifting cord supported by the winding pulley; enables the solar radiation shielding member to be led in by rotation driving the winding pulley in a rolling-up direction of the lifting cord with a driving shaft rotated by an operating means; enables the solar radiation shielding member to perform lead-out operation by rotating the winding pulley in an unwinding direction of the lifting cord by a tension exerted on the lifting cord on the basis of operation of the operating means; and stops the lead-out operation by detecting an obstacle coming into contact with the solar radiation shielding member in the lead-out operation of the solar radiation shielding member, the obstacle detection stopping device comprising: an obstacle detection means which blocks rotation of the winding pulley that supports the lifting cord when a tension in a lead-out direction is not exerted to the lifting cord; and a stopping means which blocks rotation of the driving shaft on the basis of rotation relative to the winding pulley in which rotation is blocked on the basis of function of the obstacle detection means and the driving shaft.

According to second aspect of the present invention, in the present invention according to the first aspect, the obstacle detection means is configured by a friction generating means formed between the winding pulley and a supporting member which rotatably supports the winding pulley.

According to third aspect of the present invention, in the present invention according to first aspect, the stopping means includes a cam mechanism in which the stopping means becomes an engagement state or a disengagement state with a supporting member which rotatably supports the winding pulley on the basis of rotation relative to the winding pulley and the driving shaft.

According to fourth aspect of the present invention, in the present invention according to any one of first to third aspects, the stopping means includes: a first stopping means formed nonrotatably relative to the winding pulley and movably relative thereto along an axial direction and having a sliding hole inclined with respect to an axis line of the winding pulley; a second stopping means formed rotatably relative to the first stopping means within a predetermined range and movable relative thereto in the axial direction by including a sliding projected part nonmovable relative to the winding pulley and sliding inside the sliding hole; and a third stopping means which engages with the first stopping means and stops rotation of the first stopping means, in which the first stopping means moves in the axial direction by the rotation relative to the second stopping means and stops the rotation by engaging with the third stopping means; and the second stopping means stops the rotation of the driving shaft by engagement between a controlling projected part provided in the second stopping means on the basis of the rotation stop of the first stopping means and an engaging projected part formed in the winding pulley and formed engageably with the controlling projected part.

According to fifth aspect of the present invention, in the present invention according to fourth aspect, the first stopping means is configured to arrange a plurality of braking claws, which engages with the third stopping means, formed at even angles along a circumferential direction.

According to sixth aspect of the present invention, in the present invention according to any one of first to third aspects, the stopping means is provided at only two winding pulleys arranged on both sides of the driving shaft.

### EFFECT OF THE INVENTION

According to the present invention, there can be provided an obstacle detection stopping device of a solar radiation shielding apparatus capable of suppressing wear of a lifting cord due to contact of slats with the lifting cord.

### BRIEF DESCRIPTION OF THE DRAWINGS

FIG. 1 is a schematic view of a horizontal type blind;

FIG. 2 is a side sectional view of an obstacle detection stopping device;

FIGS. 3(a) and (b) are explanation views of a supporting member;

FIGS. 4(a) and (b) are explanation views of a winding pulley;

FIGS. 5(a) and (b) are explanation views of a cam clutch; and

FIGS. 6(a), (b), and (c) are explanation views of a rotary drum.

### DESCRIPTION OF THE REFERENCE NUMERALS

3 . . . slat as solar radiation shielding member

5 . . . lifting cord

6 . . . operating device as operating means

8 . . . driving shaft

9 . . . winding pulley

9c and 9d . . . engaging projected part

11 . . . supporting member

11g . . . braking projected part as third stopping means

11i . . . coating part as friction generating means

12 . . . cam clutch as first stopping means

12c . . . braking claw

12d . . . sliding hole

13 . . . rotary drum as second stopping means

13e . . . controlling projected part

### BEST MODE FOR CARRYING OUT THE INVENTION

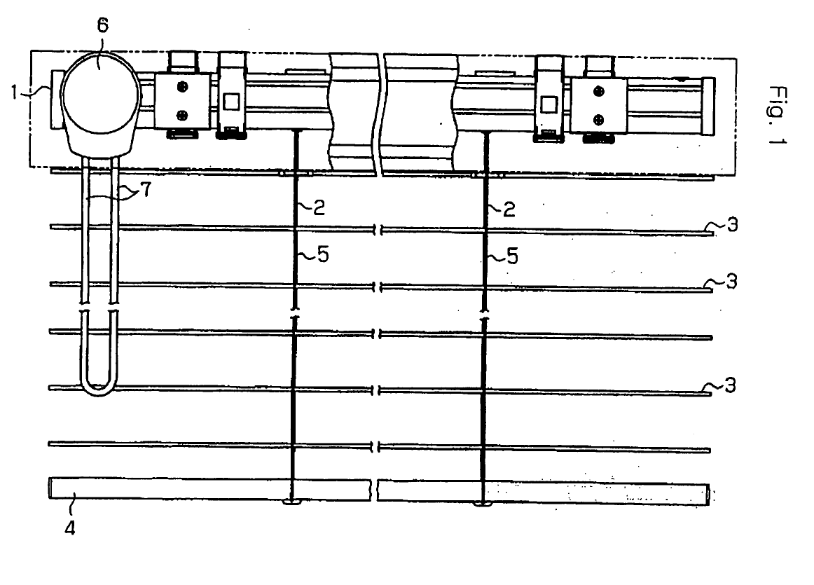

An embodiment embodied with the present invention will be described below with reference to FIG. 1 to FIG. 6. In a horizontal type blind as a solar radiation shielding apparatus shown in FIG. 1, many number of slats 3 as a solar radiation shielding member are suspended and supported via a plurality of ladder cords 2 hung from a head box 1; and a bottom rail 4 is suspended and supported at a lower end of the ladder cords 2.

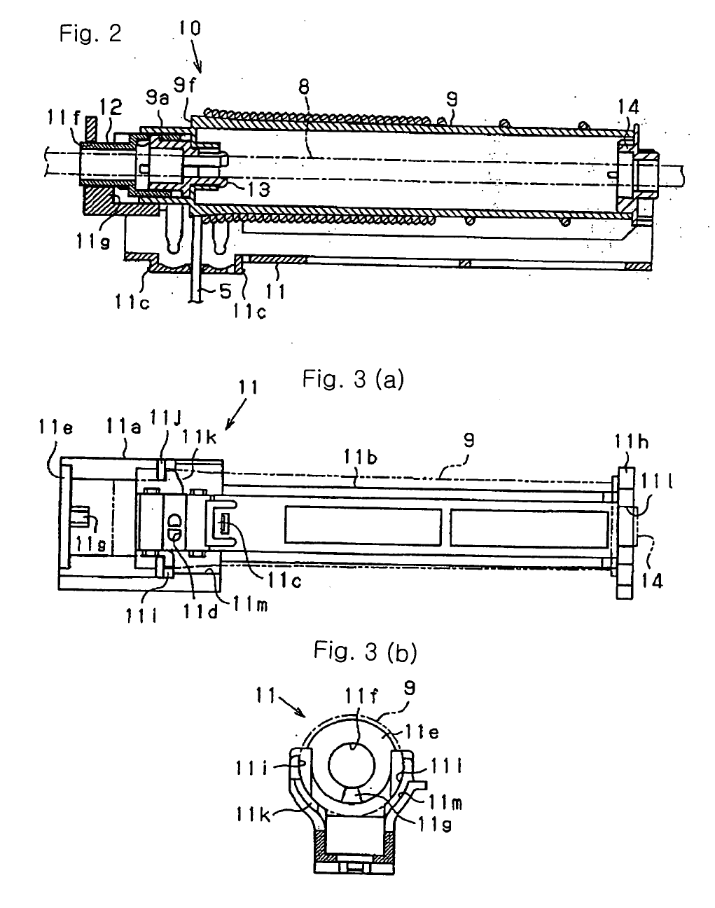

A plurality of lifting cords 5 hung from the head box 1 pass through the slats 3 in the vicinity of the ladder cords 2. The lifting cord 5 has its upper end wound around a winding pulley 9 (refer to FIG. 2) disposed in a head box 1 and its lower end connected to the bottom rail 4.

The lifting cord 5 performs rolling-up or unwinding on the basis of rotation of the winding pulley 9 and moves up and down the bottom rail 4 and the slats 3 on the basis of the rotation. Furthermore, angle adjustment of each of the slats 3 is performed in the same phase via the ladder cords 2 on the basis of the rotation of the winding pulley 9. In addition, it is configured so that the slats 3 are not further pivoted when the each slat 3 is pivoted to a substantially vertical direction.

An operating device 6 as an operating means is provided at one end of the head box 1 and an operating cord 7 is hung from the operating device 6. The operating device 6 can rotatably drive a driving shaft 8 (refer to FIG. 2), which is accommodated in the head box 1, on the basis of operation of the operating cord 7; and the winding pulley 9 is rotated by the rotation of the driving shaft 8.

The operating device 6 includes a known self-weight drop prevention device, not shown in the drawing, inside thereof. When raising operation of the bottom rail 4 and the slats 3 based on the operating cord 7 is stopped, the self-weight drop prevention device is operated to stop the rotation of the driving shaft 8, so that the bottom rail 4 and the slats 3 are suspended and supported at a desired position. Furthermore, if the operation of the self-weight drop prevention device is released by handling of the operating cord 7, the bottom rail 4 and the slats 3 are lowered on the basis of self-weight.

The driving shaft 8 is accommodated in the head box 1 across the longitudinal direction thereof. Obstacle detection stopping devices 10 are arranged at predetermined positions of the driving shaft 8; more specifically, of the lifting cords 5 which suspend and support the bottom rail 4 and the slats 3, each of the obstacle detection stopping devices 10 is arranged in the vicinity of the respective lifting cords 5 located on both sides.

As shown in FIG. 2, the obstacle detection stopping device 10 includes a supporting member 11, a cam clutch 12 as a first stopping means, a rotary drum 13 as a second stopping means, the winding pulley 9 and the like.

The supporting member 11 is fixed to the head box 1 by means of a snapfit 11c close-fitted into a square hole of the head box 1. The supporting member 11 rotatably supports the cam clutch 12, the rotary drum 13, and the winding pulley 9 between penetrating holes 11f and 11l (refer to FIG. 3(a)).

As shown in FIG. 3(a) and FIG. 3(b), the supporting member 11 includes a first support portion 11a almost covering the rotary drum 13 and the cam clutch 12; and a second support portion 11b almost covering the winding pulley 9.

The first support portion 11a and the second support portion 11b are respectively formed with a sandwiching piece 11j and a bearing portion 11h which hold the winding pulley 9 in sandwiched relation along the axial direction; and the winding pulley 9 is nonmovable in the axial direction.

A leading out opening 11d of the lifting cord 5, through which the snapfit 11c and the lifting cord 5 are rolled-up or unwound from a predetermined position, and the like are formed in the bottom of the first support portion 11a. A guiding portion 11k which guides the lifting cord 5 from the leading out opening 11d to a predetermined position of the winding pulley 9 at the time of rolling-up of the lifting cord 5 is formed on one side in the width direction of the supporting member 11 (upper side in FIG. 3(a)). A supporting portion 11m is formed at a position opposite to a guiding portion 11k. The guiding portion 11k and the supporting portion 11m are formed as a gently curved portion. Furthermore, the penetrating hole 11 and a braking projected part 11g as a third stopping means are formed at a side edge 11e of the first support portion 11a.

An inner diameter of the penetrating hole 11f is formed to be substantially the same as an outer diameter of a cylinder portion 12a of the cam clutch 12; and the cylinder portion 12a is passed through pivotably relative to the penetrating hole 11f and movably in the axial direction. The braking projected part 11g is formed under the penetrating hole 11f in the first support portion 11a. The braking projected part 11g is formed by protruding from the side edge 11e along the axial direction of the penetrating hole 11f.

The first support portion 11a includes a coating part 11i as an obstacle detection means and a friction generating means, which comes into contact with a winding portion 9b of the winding pulley 9 to be described later, from lower side. The coating part 11i comes into contact with the winding pulley 9 so that some frictional force is generated with the winding portion 9b when the winding pulley 9 rotates. The coating part 11i is formed such that an upper end thereof is located upward than the axial center of the winding pulley 9 when the coating part 11i is installed with the winding pulley 9 so that the winding pulley 9 does not come off upward of the coating part 11i when the winding pulley 9 rotates.

The second support portion 11b has a longitudinal length which is formed to be substantially the same as an axial length of the winding portion 9b of the winding pulley 9. The bearing portion 11h is formed at a longitudinal end (right end in FIG. 3(a)) of the second support portion 11b. The bearing portion 11h is formed to be substantially U-shape and rotatably supports the driving shaft 8 via a pulley cap 14 to be described later.

The winding pulley 9 is rotatably supported to the thus formed supporting member 11 via the cam clutch 12 and the pulley cap 14.

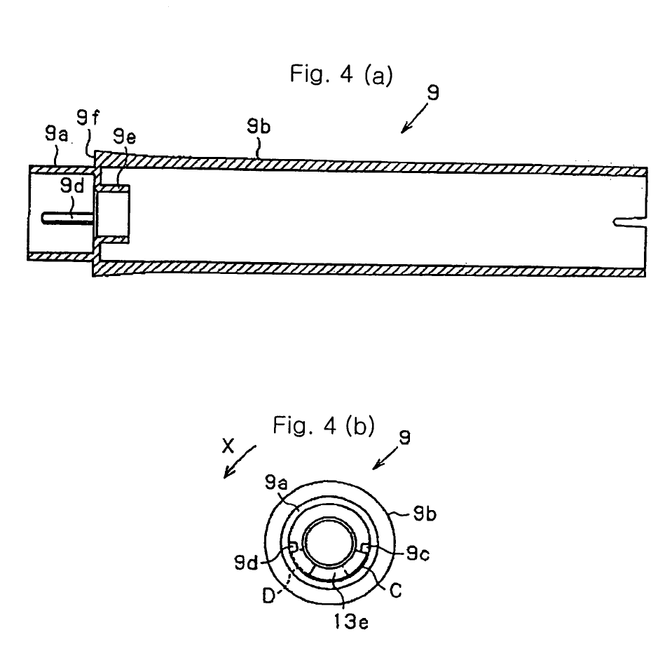

As shown in FIG. 4(a) and FIG. 4(b), the winding pulley 9 is formed to be substantially cylindrical and includes an engagement portion 9a and the winding portion 9b.

Engaging projected parts 9c and 9d protruding toward a radially inner side of the engagement portion 9a are formed on an inner circumferential surface of the engagement portion 9a. The engaging projected parts 9c and 9d are formed along an axial direction of the engagement portion 9a and arranged approximately 180° to each other in a circumferential direction of the engagement portion 9a.

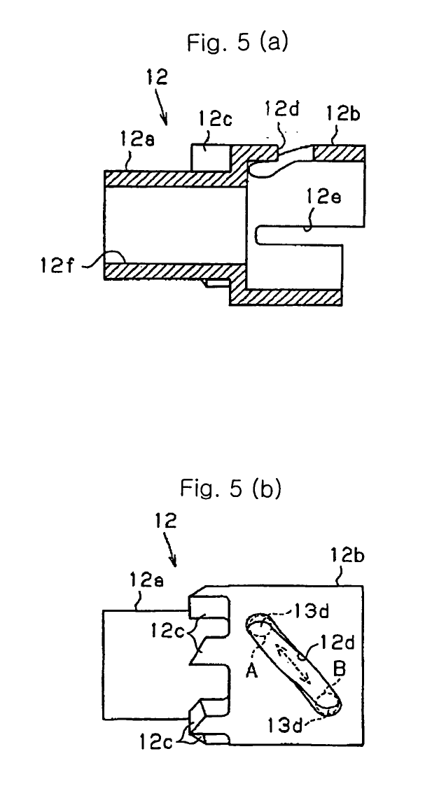

The winding portion 9b of the winding pulley 9 is set so as to be gradually small in diameter from a flange portion 9f toward an edge side (right side in FIG. 2 and FIG. 5(a)). A latching cylinder 9e is formed in a radially inner side at an end portion of the leading out opening 11d side of the winding portion 9b. The latching cylinder 9e is extendedly provided toward the edge side along the axis line of the winding portion 9b. The substantially disk-shaped pulley cap 14 (refer to FIG. 2) is attached to an end portion of the edge side of the winding portion 9b; and the driving shaft 8 is relatively rotatably penetrated to the center of the winding portion 9b.

The cam clutch 12 is accommodated in a radially inner side of the engagement portion 9a of the winding pulley 9. As shown in FIG. 5(a) and FIG. 5(b), the cam clutch 12 is formed to be a substantially cylindrical shape and includes the cylinder portion 12a and the braking portion 12b formed to be larger in diameter than the cylinder portion 12a.

The braking portion 12b has a diameter of an outer circumferential surface set to be a size being slidable with the inner circumferential surface of the engagement portion 9a of the aforementioned winding pulley 9. A braking claw 12c is formed at an end of the cylinder portion 12a side of the braking portion 12b (left side in FIG. 5(a) and FIG. 5(b)). The braking claw 12c is protruded in a serration shape toward the axial direction and engageable with the braking projected part 11g of the aforementioned supporting member 11.

The braking claw 12c is engaged with the braking projected part 11g, thereby preventing the braking claw 12c from rotating circumferentially, whereby the supporting member 11 and the cam clutch 12 are nonrotatable relative to each other. A plurality (six 60° spaces in this embodiment) of the braking claws 12c are formed at even angles along the circumferential direction of the braking portion 12b.

A sliding hole 12d and moving slits 12e are formed on a side wall of the braking portion 12b as a cam mechanism. The sliding hole 12d is formed so as to be inclined at approximately 45° with respect to the axis line of the braking portion 12b. Furthermore, length of the sliding hole 12d is set so as to be arranged across a range of angle approximately 45° in the circumferential direction of the braking portion 12b.

The moving slits 12e are formed along the axial direction of the braking portion 12b. The moving slits 12e are arranged so as to correspond to positions of the engaging projected parts 9c and 9d of the aforementioned winding pulley 9. The moving slits 12e and the engaging projected parts 9c and 9d are engaged, whereby the cam clutch 12 and the winding pulley 9 are installed nonrotatably relative to each other and rotatably relative to each other along the axial direction.

Therefore, the cam clutch 12 is moved relative to the axial direction of the winding pulley 9, thereby being nonrotatable relative to the supporting member 11 when the braking claw 12c is engaged with the braking projected part 11g; and, thereby being rotatable relative to the supporting member 11 when the engagement state between the braking claw 12c and the braking projected part 11g is released.

In the side wall of the braking portion 12b in the circumferential direction, one (upside in FIG. 5(a)) sandwiching both the moving slits 12e is formed so as to protrude farther toward the axial direction than the other (lower side in FIG. 5(a)).

As shown in FIG. 2, the rotary drum 13 is accommodated in a radially inner side of the cam clutch 12. Furthermore, the driving shaft 8 penetrates in the cylinder portion 12a; however, a cylinder hole 12f is larger than a diameter of hexagon axis of the driving shaft 8, thereby being rotatable relative to the driving shaft 8.

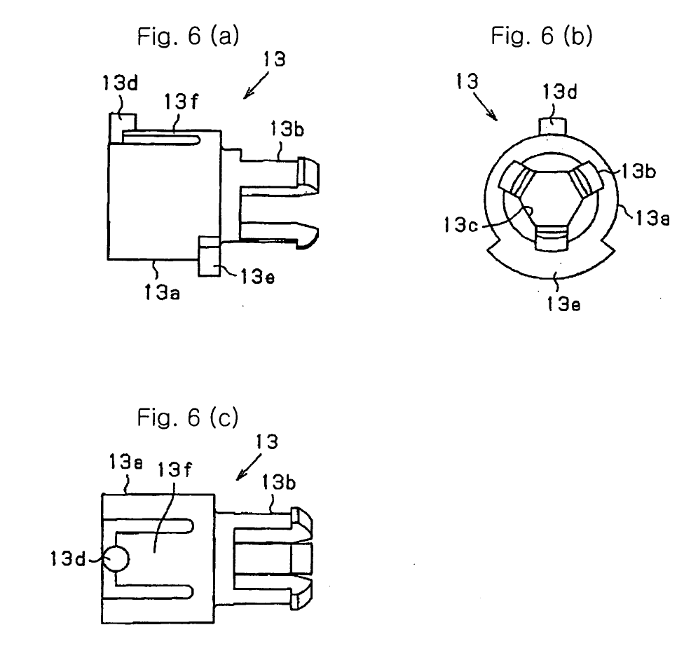

As shown in FIGS. 6(a) to (c), the rotary drum 13 includes a main body portion 13a and latching claws 13b. The main body portion 13a is formed to be a substantially cylindrical shape and a fixing hole 13c being an equilateral hexagon shape is formed at the center thereof. The rotary drum 13 has the driving shaft 8 being hexagon shaped in section having the same size as the fixing hole 13c and integrally rotated together with the driving shaft 8.

Three latching claws 13b are formed at even spaces (space of 120°) along the circumferential direction of the main body portion 13a and elastically deformable toward the center of the latching cylinder 9e when being inserted into the latching cylinder 9e. The latching claws 13b are formed to be a diameter smaller than the main body portion 13a; and the latching cylinder 9e of the aforementioned winding pulley 9 is sandwiched toward the axial direction by the main body portion 13a and the respective claws 13b so that the rotary drum 13 and the winding pulley 9 are not moved relative to each other in the axial direction (refer to FIG. 2).

Two cutouts are formed in the main body portion 13d along the axial direction and an arm 13f is formed by the cutouts. A sliding projected part 13d protruding toward outward in the radial direction of the rotary drum 13 is formed in an edge of the arm 13f. The arm 13f has flexibility along the radial direction of the rotary drum 13 by the cutouts so that the edge distorts toward the center together with the sliding projected part 13d when being installed inside the cam clutch 12. The sliding projected part 13d is formed by protruding in a substantially cylinder shape and slidably formed in the sliding hole 12d of the aforementioned cam clutch 12.

A controlling projected part 13e protruding toward radially outwardly is formed on one end (right end in FIG. 6(a) and FIG. 6(c)) on the latching claw 13b side of the main body portion 13a. The controlling projected part 13e is arranged at a position substantially opposite to the aforementioned sliding projected part 13d in the circumferential direction of the main body portion 13a. Furthermore, the controlling projected part 13e is formed by protruding in a predetermined angle range in the circumferential direction of the main body portion 13a; and an amount of protrusion thereof is set so as to come into contact with the engaging projected parts 9c and 9d in the circumferential direction when the rotary drum 13 is rotated relative to the winding pulley 9.

The thus formed rotary drum 13 is installed so that the sliding projected part 13d is accommodated inside the sliding hole 12d of the cam clutch 12. Therefore, as shown in FIG. 5(b), the rotary drum 13 and the cam clutch 12 are movable relative to each other only in the range where the sliding projected part 13d is moved relative to the inside of the sliding hole 12d.

Specifically, when the sliding projected part 13d is located at A, the cam clutch 12 is placed at the nearest side of the winding pulley 9 (right side in FIG. 2), whereby the engagement state between the braking claw 12c and the braking projected part 11g is released. Meanwhile, when the sliding projected part 13d is located at B, the cam clutch 12 is placed at the farthest side of the winding pulley 9 (left side in FIG. 2), whereby the braking claw 12c and the braking projected part 11g become the engagement state.

Furthermore, the rotary drum 13 is installed so that the controlling projected part 13e is arranged between the engaging projected parts 9c and 9d of the winding pulley 9. Therefore, as shown in FIG. 4(b), the rotary drum and the winding pulley 9 are movable relative to each other only in the range where the controlling projected part 13e is moved relative to between the engaging projected parts 9c and 9d of the winding pulley 9. The range where the controlling projected part 13e is moved relative to between the engaging projected parts 9c and 9d is set to be substantially the same as the range where the sliding projected part 13d is moved relative to the inside of the sliding hole 12d. That is, the controlling projected part 13e is rotatable relative to the engaging projected parts 9c and 9d in the range of approximately 45°.

Specifically, the sliding projected part 13d is placed at A (refer to FIG. 5(b)) when the controlling projected part 13e is located at C; and the sliding projected part 13d is placed at B (refer to FIG. 5(b)) when the controlling projected part 13e is located at D (refer to FIG. 4(b)).

Next, function of the thus configured horizontal type blind will be described. First, operation in raising the horizontal type blind will be described. When the operating cord 7 is operated to rotate the driving shaft 8 in a raising direction of the horizontal type blind, the rotation is transmitted to the rotary drum 13 to rotate the rotary drum 13 in X direction shown in FIG. 4. Consequently, the rotary drum 13 is rotated relative to the winding pulley 9 and the cam clutch 12 till the sliding projected part 13d moves to A and the controlling projected part 13e moves to C.

Consequently, the cam clutch 12 is moved toward the right direction in FIG. 2 to release the engagement state between the braking claw 12c of the cam clutch 12 and the braking projected part 11g of the supporting member 11, whereby the cam clutch 12 becomes rotatable relative to the supporting member 11.

Then, the rotary drum 13 is nonrotatable relative to the cam clutch 12 and the winding pulley 9 any more. Therefore, when the driving shaft 8 is further rotated in the raising direction, the rotary drum 13 is rotated in the raising direction integrally with the cam clutch 12 and the winding pulley 9 to perform the raising operation of the horizontal type blind.

Next, operation in lowering the horizontal type blind will be described. The operation in lowering the horizontal type blind is performed using self-weight of the slats 3 and the bottom rail 4 and therefore driving force in lowering is transmitted from the winding pulley 9 toward the driving shaft 8.

When the winding pulley 9 and the cam clutch 12 are rotated in a lowering direction, the rotary drum 13 is such that the sliding projected part 13d located at A (refer to FIG. 5(b)) is received by a force exerted from the sliding hole 12d toward a lower side shown in the drawing; and the controlling projected part 13e located at C (refer to FIG. 4(b)) is received by a force exerted from the engaging projected part 9c toward a clockwise direction shown in the drawing. Therefore, when the winding pulley 9 and the cam clutch 12 are rotated toward the lowering direction, the rotation toward the lowering direction is instantaneously transmitted to the rotary drum 13 and the driving shaft 8.

While the lowering operation of the horizontal type blind is performed, when the bottom rail 4 collides with an obstacle, the bottom rail 4 inclines toward the center of gravity side at a position collided with the obstacle as a supporting point. That is, of the obstacle detection stopping devices 10 arranged at both ends of the driving shaft 8, self-weight of mainly the slats 3 and the bottom rail 4 is applied to one obstacle detection stopping device 10 situated opposite to the supporting point with respect to the center of gravity.

Therefore, in the other obstacle detection stopping device 10 to which the self-weight of the slats 3 and the bottom rail 4 is not applied, rotation of the winding pulley 9 is stopped by friction between the coating part 11i and the outer circumferential surface of the base end side (left side in FIG. 2 and FIG. 5(a)) of the winding portion 9b; and with the stop, transmission of a rotating force from the winding pulley 9 and the cam clutch 12 to the rotary drum 13 and the driving shaft 8 is stopped.

At this time, unwinding of the lifting cord 5 by the obstacle detection stopping device 10 to which the self-weight of the slats 3 and the bottom rail 4 is not applied, is stopped on the basis of stop of the rotation of the winding pulley 9; and therefore, the lifting cord 5 does not sway in the horizontal direction.

Meanwhile, in the obstacle detection stopping device 10 situated opposite to the supporting point with respect to the center of gravity, unwinding of the lifting cord 5 is continuously performed by the self-weight of the slats 3 and the bottom rail 4, irrespective of the rotation state of the obstacle detection stopping device 10 situated on the supporting point side with respect to the center of gravity. Therefore, the rotary drum 13 and the driving shaft 8 are also rotated in the lowering direction via the winding pulley 9 and the cam clutch 12.

At this time, in the obstacle detection stopping devices 10 attached at positions in the vicinity of both ends in the longitudinal direction (horizontal direction in FIG. 1) of the horizontal type blind, one winding pulley 9 becomes a stop state and the other winding pulley 9 becomes a rotation state; however, both are penetrated by one driving shaft 8 and therefore rotation is transmitted to the driving shaft 8 by the winding pulley 9 in the rotation state.

Therefore, in the obstacle detection stopping device 10 in which rotation of the winding pulley 9 is stopped, the winding pulley 9 and the cam clutch 12 do not rotate; on the other hand, only the rotary drum 13 is rotated in the lowering direction. As the result, the winding pulley 9 and the cam clutch 12 and the rotary drum 13 are rotated relative to each other, whereby the sliding projected part 13d formed in the rotary drum 13 moves from A to B in the sliding hole 12d and the controlling projected part 13e moves from C to D between the engaging projected parts 9c and 9d of the winding pulley 9.

Thus, when the sliding projected part 13d is located at B and the controlling projected part 13e is located at D, the braking claw 12c of the cam clutch 12 and the braking projected part 11g of the supporting member 11 are in an engagement state and therefore the cam clutch 12 becomes nonrotatable relative to the supporting member 11. As the result, the sliding projected part 13d moved to B in the sliding hole 12d cannot be further moved downward in FIG. 5(b) and consequently its rotating motion is stopped.

On the other hand, in the obstacle detection stopping device 10 in which the winding pulley 9 is rotated by the self-weight of the slats 3 and the bottom rail 4, the sliding projected part 13d is located at A in the sliding hole 12d and it becomes in a state (state located at C in FIG. 4) where the engaging projected part 9c comes into contact with the controlling projected part 13e. Therefore, when rotation of the driving shaft 8 and the rotary drum 13 is stopped, the cam clutch 12 cannot move the sliding hole 12d toward lower side shown in FIG. 5(b) and the winding pulley 9 cannot pivot the controlling projected part 13e in a clockwise direction. Therefore, upon stopping the driving shaft 8, pivotal movement toward the lowering direction by the self-weight of the slats 3 and the bottom rail 4 is stopped.

In this case, unwinding of the lifting cord 5 by the obstacle detection stopping device 10 in which the winding pulley 9 is rotated by the self-weight of the slats 3 and the bottom rail 4 is also stopped on the basis of stop of rotation of the winding pulley 9 and therefore the lifting cord 5 does not sway in the horizontal direction.

In addition, as described above, the braking claws 12c and the braking projected parts 11g in either one of the obstacle detection stopping devices 10 arranged on both sides of the horizontal type blind are in an engagement state, after that, lowering operation of the slats 3 and the bottom rail 4 is disabled till the engagement state between the braking claw 12c and the braking projected part 11g is released. In such a case, the operating cord 7 is operated to rotate the driving shaft 8 in a raising direction once and the engagement between the braking claw 12c and the braking projected part 11g is released, whereby lowering operation of the slats 3 and the bottom rail 4 is possible again.

As described above, according to this embodiment, the following effects can be exhibited. (1) When the bottom rail 4 collides with an obstacle in lowering operation of the slats 3 and the bottom rail 4, the obstacle detection stopping device 10 stops rotation of the winding pulley 9 so that unwinding of the lifting cord 5 is not performed. Therefore, after the bottom rail 4 collides with an obstacle, slack is not generated in the lifting cord 5 and generation of twine in the lifting cord 5 can be prevented.

(2) The obstacle detection stopping device 10 stops unwinding of the lifting cord 5 by stopping the rotation of the winding pulley 9 itself and therefore the lifting cord 5 does not sway in the horizontal direction with the stopping operation. Therefore, the lifting cord 5 does not come in contact with the slats 3 in stopping the unwinding of the lifting cord 5 and consequently wear of the lifting cord 5 can be suppressed.

(3) In stopping the rotation of the driving shaft 8, the braking claw 12c of the cam clutch 12 is engaged with the braking projected part 11g of the supporting member 11 on the basis of the rotation of the driving shaft 8, whereby lowering operation of the horizontal type blind can be stopped on the axis line of the winding pulley 9. Therefore, a mechanism for detecting collision between the bottom rail 4 and an obstacle and a mechanism for stopping the lowering operation of the horizontal type blind are not required to protrude outward in the radial direction of the winding pulley 9. Therefore, the head box 1 can be reduced in size.

(4) A plurality (six 60° spaces in this embodiment) of the braking claws 12c are formed at even angles along the circumferential direction of the braking portion 12b. Therefore, when the bottom rail 4 collides with an obstacle, the braking claw 12c moves toward the braking projected part 11g formed on the supporting member 11; however, the braking claw 12c can engage with the braking projected part 11g instantaneously (before rotating 60°). Therefore, when the bottom rail 4 collides with an obstacle, the lowering operation of the horizontal type blind can be rapidly stopped.

(5) In the supporting member 11, the coating parts 11i come into contact with the winding portion 9b of the winding pulley 9 from both lower sides to generate some frictional force between the winding pulley 9 and the coating parts 11i. Therefore, when the bottom rail 4 collides with an obstacle, the rotation of the winding pulley 9 is instantaneously stopped, whereby generation of slack in the lifting cord 5 and generation of twine in the lifting cord 5 with the generation of the slack in the lifting cord 5 can be suppressed.

In addition, the above-mentioned embodiment may be implemented in the following embodiment.

In the above-mentioned embodiment, the sliding hole 12d is formed so as to be inclined at approximately 45° with respect to the axis line of the braking portion 12b. However, the inclined angle of the sliding hole 12d may be appropriately changed. Furthermore, movement speed toward the axial direction of the cam clutch 12 can be adjusted by changing the inclined angle of the sliding hole 12d.

In the above-mentioned embodiment, the coating parts 11i come into contact with the winding portion 9b of the winding pulley 9 from the lower sides to generate the frictional force between the winding pulley 9 and the coating part 11i. However, it may be such that a means which generates a force to block rotating motion of the winding pulley 9 is provided; for example, it may be configured to generate a force to block the rotating motion of the winding pulley 9 using clutch springs, friction disks, magnets or the like.

Furthermore, it may be configured to generate a force to block the rotating motion of the winding pulley 9 by means of sandwiching the flange portion 9f of the winding pulley 9 and the pulley cap 14 with the supporting member 11 by narrowing spacing between the bearing portion 11h and the sandwiching piece 11j.

Further, it may be configured to generate a force to block the rotating motion of the winding pulley 9 by means of bringing the guiding portion 11k and the supporting portion 11m into contact with the lifting cord 5 wound around the winding pulley 9 by reducing diameters of the guiding portion 11k and the supporting portion 11m.

In the above-mentioned embodiment, the solar radiation shielding apparatus is a horizontal type blind and the obstacle detection stopping device 10 is arranged in the horizontal type blind; however, it may be such that the solar radiation shielding apparatus includes the bottom rail and the lifting cord. Therefore, the solar radiation shielding apparatus may be a pleated curtain.

Furthermore, the solar radiation shielding apparatus may be a rolled up curtain by using a spindle in place of the bottom rail.

In the above-mentioned embodiment, the obstacle detection stopping devices 10 are arranged in the winding pulleys 9 which wind the lifting cords 5 hung from positions in the vicinity of both ends in the longitudinal direction (horizontal direction in FIG. 1) of the horizontal type blind. However, the obstacle detection stopping device 10 may be arranged in all winding pulleys 9 which wind the lifting cords 5.

In the above-mentioned embodiment, lowering operation of the horizontal type blind is performed using self-weight of the slats 3 and the bottom rail 4. However, it may not be such that the lowering operation of the horizontal type blind is performed on the basis of self-weight of the slats and the bottom rail; for example, it may be configured to perform the lowering operation of the horizontal type blind on the basis of a tension means which always tenses the solar radiation shielding member toward the lowering direction. In addition, arrangement of the bottom rail can be eliminated by means of this configuration;

Furthermore, a lead-in or lead-out direction of the solar radiation shielding member can be changed by means of the tension means. Therefore, for example, it may be configured to include the obstacle detection stopping device in the solar radiation shielding apparatus in which the solar radiation shielding member is led in or led out in the horizontal direction.

In the above-mentioned embodiment, the driving shaft 8 is rotated in the unwinding direction by self-weight of the slats 3 and the bottom rail 4. However, the driving shaft 8 may be configured to be directly rotated in the unwinding direction with the operating cord 7. According to this configuration, engagement between the braking projected part 11g and the braking claw 12c can be directly performed by operation of the operating cord 7 and therefore the obstacle detection stopping device 10 can be configured by including at least one each of the lifting cord 5 and winding pulley 9. Furthermore, the rotation of the winding pulley 9 can be stopped without inclining the bottom rail 4.

1. An obstacle detection stopping device of a solar radiation shielding apparatus, which rotatably supports a winding pulley; supports a solar radiation shielding member by a lifting cord supported by said winding pulley; enables said solar radiation shielding member to be led in by rotation driving said winding pulley in a rolling-up direction of the lifting cord with a driving shaft rotated by an operating means; enables said solar radiation shielding member to perform lead-out operation by rotating said winding pulley in an unwinding direction of the lifting cord by a tension exerted on said lifting cord on the basis of operation of said operating means; and stops the lead-out operation by detecting an obstacle coming into contact with said solar radiation shielding member at the time of the lead-out operation of said solar radiation shielding member,
said obstacle detection stopping device comprising:
an obstacle detection means which blocks rotation of said winding pulley that supports said lifting cord when a tension in a lead-out direction is not exerted to said lifting cord; and
a stopping means which blocks rotation of said driving shaft on the basis of rotation relative to said winding pulley in which rotation is blocked on the basis of function of said obstacle detection means and said driving shaft.

2. The obstacle detection stopping device of the solar radiation shielding apparatus according to claim 1, wherein said obstacle detection means is configured by a friction generating means formed between said winding pulley and a supporting member which rotatably supports said winding pulley.

3. The obstacle detection stopping device of the solar radiation shielding apparatus according to claim 1, wherein said stopping means includes a cam mechanism in which said stopping means becomes an engagement state or a disengagement state with a supporting member which rotatably supports said winding pulley on the basis of rotation relative to said winding pulley and said driving shaft.

4. The obstacle detection stopping device of the solar radiation shielding apparatus according to claim 1,
wherein said stopping means includes:
a first stopping means formed nonrotatably relative to said winding pulley and movably relative thereto along an axial direction and having a sliding hole inclined with respect to an axis line of said winding pulley;
a second stopping means formed rotatably relative to said first stopping means within a predetermined range and movably relative thereto in the axial direction by including a sliding projected part nonmovable relative to said winding pulley and sliding inside said sliding hole; and
a third stopping means which engages with said first stopping means and stops rotation of said first stopping means,
in which said first stopping means moves in the axial direction by the rotation relative to said second stopping means and stops the rotation by engaging with said third stopping means; and
said second stopping means stops the rotation of said driving shaft by engagement between a controlling projected part provided in said second stopping means the basis of the rotation stop of said first stopping means and an engaging projected part formed in said winding pulley and formed engageably with said controlling projected part.

5. The obstacle detection stopping device of the obstacle detection stopping device according to claim 4, wherein said first stopping means is configured to arrange a plurality of braking claws, which engages with said third stopping means, formed at even angles along a circumferential direction.

6. The obstacle detection stopping device of the solar radiation shielding apparatus according to claim 1, wherein said stopping means is provided at only two winding pulleys arranged on both sides of said driving shaft.

7. The obstacle detection stopping device of the solar radiation shielding apparatus according to claim 2,
wherein said stopping means includes:
a first stopping means formed nonrotatably relative to said winding pulley and movably relative thereto along an axial direction and having a sliding hole inclined with respect to an axis line of said winding pulley;
a second stopping means formed rotatably relative to said first stopping means within a predetermined range and movably relative thereto in the axial direction by including a sliding projected part nonmovable relative to said winding pulley and sliding inside said sliding hole; and
a third stopping means which engages with said first stopping means and stops rotation of said first stopping means,
in which said first stopping means moves in the axial direction by the rotation relative to said second stopping means and stops the rotation by engaging with said third stopping means; and
said second stopping means stops the rotation of said driving shaft by engagement between a controlling projected part provided in said second stopping means the basis of the rotation stop of said first stopping means and an engaging projected part formed in said winding pulley and formed engageably with said controlling projected part.

8. The obstacle detection stopping device of the solar radiation shielding apparatus according to claim 3,
wherein said stopping means includes:
a first stopping means formed nonrotatably relative to said winding pulley and movably relative thereto along an axial direction and having a sliding hole inclined with respect to an axis line of said winding pulley;
a second stopping means formed rotatably relative to said first stopping means within a predetermined range and movably relative thereto in the axial direction by including a sliding projected part nonmovable relative to said winding pulley and sliding inside said sliding hole; and
a third stopping means which engages with said first stopping means and stops rotation of said first stopping means,
in which said first stopping means moves in the axial direction by the rotation relative to said second stopping means and stops the rotation by engaging with said third stopping means; and
said second stopping means stops the rotation of said driving shaft by engagement between a controlling projected part provided in said second stopping means the basis of the rotation stop of said first stopping means and an engaging projected part formed in said winding pulley and formed engageably with said controlling projected part.

9. The obstacle detection stopping device of the obstacle detection stopping device according to claim 7, wherein said first stopping means is configured to arrange a plurality of braking claws, which engages with said third stopping means, formed at even angles along a circumferential direction.

10. The obstacle detection stopping device of the obstacle detection stopping device according to claim 8, wherein said first stopping means is configured to arrange a plurality of braking claws, which engages with said third stopping means, formed at even angles along a circumferential direction.

11. The obstacle detection stopping device of the solar radiation shielding apparatus according to claim 2, wherein said stopping means is provided at only two winding pulleys arranged on both sides of said driving shaft.

12. The obstacle detection stopping device of the solar radiation shielding apparatus according to claim 3, wherein said stopping means is provided at only two winding pulleys arranged on both sides of said driving shaft.
